(19) United States
(12) Patent Application Publication
(10) Pub. No.: US 2016/0051997 A1
(43) Pub. Date: Feb. 25, 2016

(54) Electrostatic Spray System

(71) Applicant: Carlisle Fluid Technologies, Inc., Charlotte, NC (US)

(72) Inventor: David Martin Seitz, Riga, MI (US)

(21) Appl. No.: 14/832,936

(22) Filed: Aug. 21, 2015

Related U.S. Application Data
(60) Provisional application No. 62/041,440, filed on Aug. 25, 2014.

(51) Int. Cl. B05B 5/053; B05B 5/16; B05B 5/03

(52) U.S. Cl. CPC B05B 5/053; B05B 5/03; B05B 5/1691

(57) ABSTRACT

A system including an electrostatic spray system, including a tank configured to carry a fluid, a power supply system coupled to the tank and configured to electrically charge the fluid while spraying, and a manual actuator coupled to the power supply system, wherein the manual actuator is configured to drive power production by the power supply system.

### CROSS-REFERENCE TO RELATED APPLICATION

This application claims priority to and benefit of U.S. Application No. 62/041,440 entitled “Electrostatic Spray System,” filed on Aug. 25, 2014, which is hereby incorporated by reference in its entirety.

### BACKGROUND

The invention relates generally to an electrostatic spray system.

Electrostatic tools spray electrically charged materials to more efficiently coat objects. For example, electrostatic tools may be used to paint objects. In operation, a grounded target attracts electrically charged materials sprayed from an electrostatic spray system. As the electrically charged material contacts the grounded target, the material loses the electrical charge.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a perspective view of an embodiment of an electrostatic spray system;

FIG. 2 is a cross-sectional side view of an embodiment of a power supply system coupled to a mechanical driver;

FIG. 3 is a cross-sectional side view of an embodiment of a power supply system coupled to a mechanical driver; and

FIG. 4 is a cross-sectional side view of an embodiment of a power supply system coupled to a mechanical driver.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

The present disclosure is generally directed to a portable and/or wearable electrostatic spray system (e.g., an electrostatic backpack spray system) that enables a mobile operator to simultaneously pressurize and electrically charge fluid during spraying operations (e.g., spraying plants). For example, the electrostatic spray system may include a manual actuator (e.g., lever, a wheel, a pedal, a pull-string, or any combination thereof) that couples to a compressor (e.g., pump) and to a power supply system. In operation, the compressor uses the mechanical motion of the manual actuator to pressurize a fluid in a tank, while the power supply system uses the mechanical motion to generate electricity. In some embodiments, the power supply system may use the mechanical power of the manual actuator to generate electricity in combination with electricity from another source (e.g., a battery, a photovoltaic cell, an electric generator, a capacitor, an electric generator driven by an internal combustion engine, and/or an external electrical energy source). In other embodiments, the electrostatic spray system may only use electrical power from a battery, a photovoltaic cell, an electrical generator, a capacitor, an electric generator driven by an internal combustion engine, and/or an external electrical energy source (e.g., a power cord coupled to an outlet) to electrically charge the fluid exiting the electrostatic spray system.

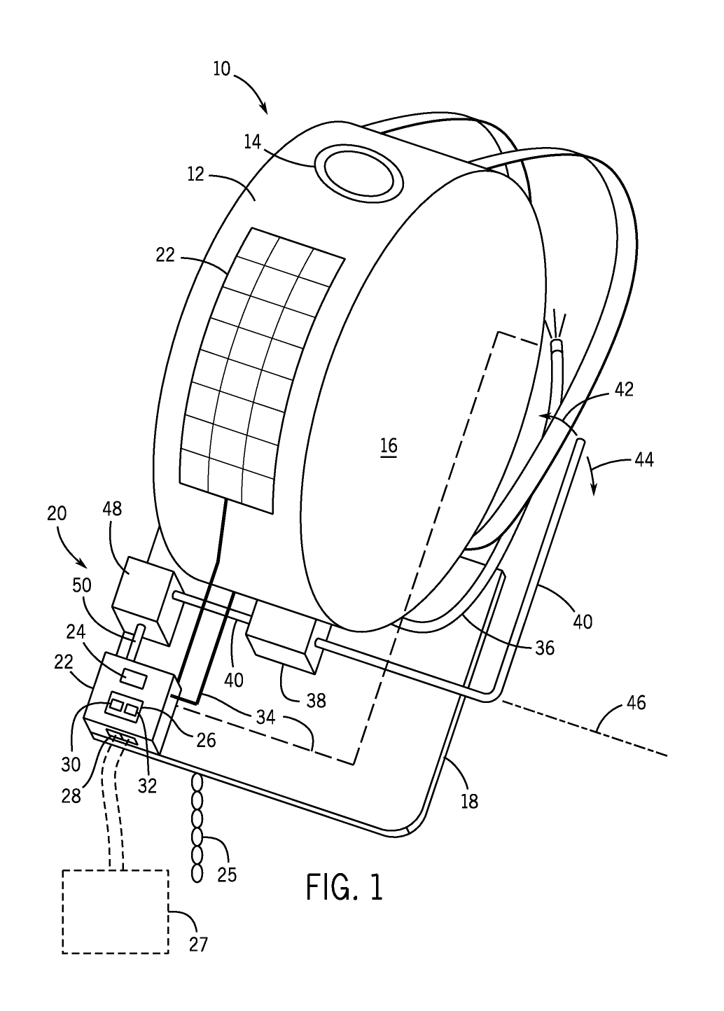

FIG. 1 is a perspective view of an embodiment of an electrostatic spray system 10. As explained above, the electrostatic spray system 10 is a wearable electrostatic spray system (e.g., an electrostatic backpack spray system) that enables an operator to carry, pressurize, and electrically charge a fluid (e.g., pesticide, chemicals, treatment fluid) while spraying a target (e.g., plants). The electrostatic spray system 10 includes a tank 12 with a lid 14 that receives and stores fluid within a cavity 16. Coupled to the tank 12 is a frame 18 that carries a power supply system 20 that enables electrostatic charging of the fluid carried by the tank 12. In some embodiments, the electrostatic spray system 10 may not include a frame 18; instead, the power supply system 20 may couple directly to the tank 12.

In order to charge the fluid, the power supply system 20 may include a power source 22, a cascade 24, and a controller 26. Depending on the embodiment, the power source may be a battery, a photovoltaic cell, an electric generator driven by a mechanical driver, an electrical generator driven by an internal combustion engine, a capacitor, and/or an external electrical energy source 27 that couples to the electrostatic spray system 10 through an outlet 28. In operation, the controller 26 may use a processor 30 that executes instructions stored by the memory 32 to control the delivery of the electrical signal or current (e.g., control amount of power, convert alternating current into direct current) from the power source 22 to the cascade 24. As the cascade 24 receives the electrical signal, the cascade 24 increases the voltage enabling electrostatic charging of the fluid. In some embodiments, the controller 26 may also execute instructions to control the increase in voltage of the electrical signal by the cascade 24. After passing through the cascade 24, the electrical signal passes through conductive cables 34 that conduct the electrical signal to the tank 12 and/or a hose 36, wherein the electrical signal charges the fluid. In some embodiments, the electrostatic spray system 10 may include a grounding device 25 to complete the electrical circuit and ground an operator. For example, the grounding device 25 may be a metal chain, metal wire, etc. that couples to the electrostatic spray system 10 or operator and is dragged along the ground.

As illustrated, the hose 36 couples to the tank 34 and directs fluid flow out of the tank 12. For example, the hose 36 may be a flexible hose that enables the operator to control the direction of the fluid spray. To facilitate discharge of the fluid, the electrostatic spray system 10 may include a compressor 38 that pumps a gas (e.g., air) into the tank, which pressurizes the fluid. The pressure within the tank 12 then drives the fluid out of the tank 12 through the hose 36 and towards a target. As illustrated, the compressor 38 couples to a manual actuator 40 (e.g., lever), which enables the operator to actuate the compressor 38 and increase pressure within the tank 40. More specifically, the operator may rotate the manual actuator 40 in clockwise and counter clockwise directions 42 and 44, which rotates the manual actuator 40 about the axis 46. In some embodiments, the manual actuator 40 may also couple to a mechanical driver 48 that drives power production by a power source 22. For example, the mechanically driver 48 may be a cam or gear coupled to one or more shafts 50 that drive a magnet within an electric generator. Accordingly, the operator may simultaneously pressurize and electrically charge the fluid by moving the manual actuator 40, which actuates the compressor 38 and the mechanical driver 48.

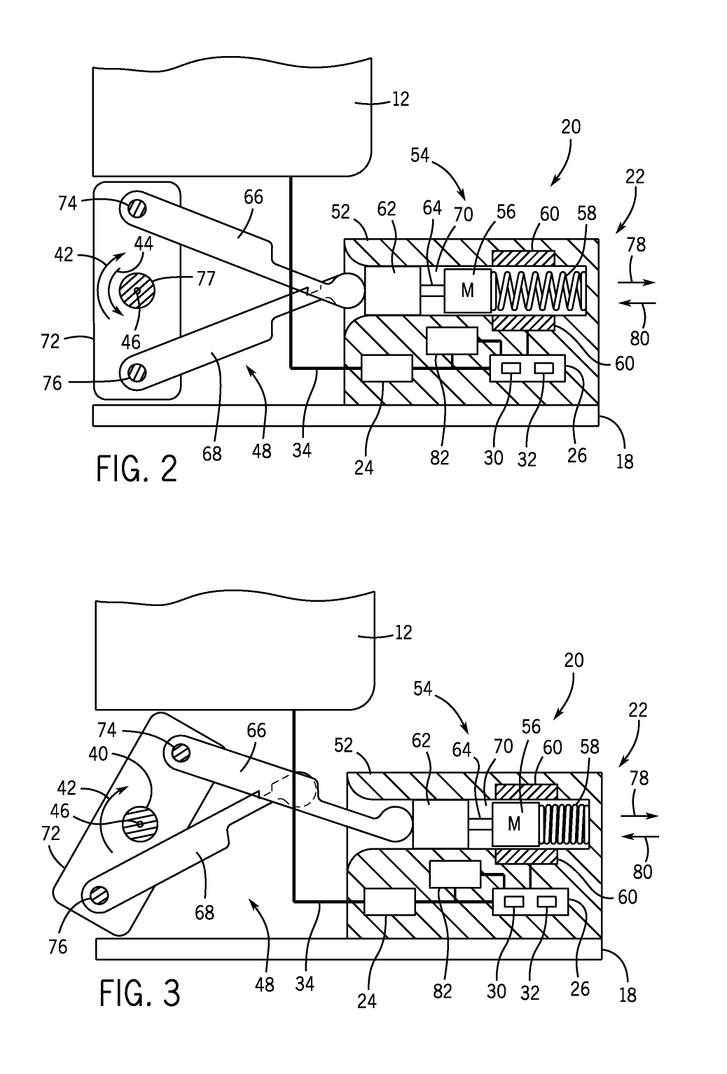

FIG. 2 is a cross-sectional side view of an embodiment of a power supply system 20 coupled to a mechanical driver 48. As illustrated, the power supply system 20 includes a housing 52 that houses the cascade 24, the controller 26, and the power source 22. In FIG. 2, the power source 22 is an electric generator 54. The electric generator 54 includes a magnet 56 (e.g., permanent magnet), spring 58 (e.g., helical spring or wave spring), and stator coils 60. As illustrated, the magnet 56 couples to a plunger 62 with a shaft 64; however, in some embodiments the magnet 56 and plunger 62 may be a single rod made entirely out of magnetic material, or a rod with a portion that is magnetic and a portion that is non-magnetic. In operation, the mechanical driver 48 drives first and second shafts 66 and 68 into contact with the plunger 62 to move the magnet 56 within a cavity 70.

As illustrated, mechanical driver 48 may be a cam 72 that couples to the first and second shafts 66 and 68 with respective pins 74 and 76. The cam 72 includes an aperture 77 that enables the cam 72 to couple to the manual actuator 40. In operation, rotation of the manual actuator 40 rotates the cam 72 about the axis 46. As the cam 72 rotates, about the axis 46, in the clockwise and counter-clockwise directions 42, 44, the cam 72 drives the first and second shafts 66 and 68 into and out of the cavity 70 in axial directions 78 and 80. For example, as the cam 72 rotates in the clockwise direction 42, the cam 72 drives the first shaft 66 into the cavity 70, while simultaneously retracting the second shaft 68. Likewise, when the cam 72 rotates in the counter-clockwise direction 44, cam 72 drives the second shaft 68 into the cavity 70 while simultaneously retracting the first shaft 66. The alternating motion of the first and second shafts 66 and 68 enables the magnet 56 to move axially within the cavity 70 and therefore in and out of the stator coils 60 that circumferentially surround the cavity 70. The changing magnetic field, induced by the motion of the permanent magnet 56 within the cavity 70, forms an electrical signal (e.g., current) within the stator coils 60 that travels from the stator coils 60 to the controller 26. As the electrical signal enters the controller 26, the controller 26 adjusts the electrical signal (e.g., convert alternating current into direct current). The electrical signal then exits the controller 26 and enters the cascade 24. In the cascade 24, the voltage of the electrical signal is increased and then transmitted through the cable 34 to the tank 12 and/or hose 36 to electrically charge the fluid. In some embodiments, the power supply system 20 may include a battery or capacitor 82 that stores electrical power generated by the electrical generator 54 (e.g., when the electrical generator 54 produces excess power). The controller 26 may then release the electrical power to the cascade to electrically charge the fluid or supplement power production by the electric generator 54. In some embodiments, the battery or capacitor 82 may receive power from another power source (e.g., photovoltaic cell, external power source) enabling the controller 26 to supplement or replace power production by the electric generator 54.

FIG. 3 is a cross-sectional side view of an embodiment of a power supply system 20 coupled to a mechanical driver 48. As illustrated, when the manual actuator 40 rotates the cam 72 in the clockwise direction 42, the cam 72 drives the first shaft 66 into the cavity 70, while simultaneously retracting the second shaft 68. As the first shaft 66 enters the cavity 70, the shaft 70 drives the plunger 62 and magnet 56 in axial direction 78 compressing the spring 58. The movement of the magnet 56 through the stator coils 60 then changes the magnetic field, forming the electrical signal (e.g., current) within the stator coils 60 that travels from the stator coils 60 to the controller 26. As the electrical signal enters the controller 26, the controller 26 adjusts the electrical signal (e.g., convert alternating current into direct current). The electrical signal then exits the controller 26 and enters the cascade 24. In the cascade 24, the voltage of the electrical signal is increased and then transmitted through the cable 34 to the tank 12 and/or hose 36 to electrically charge the fluid.

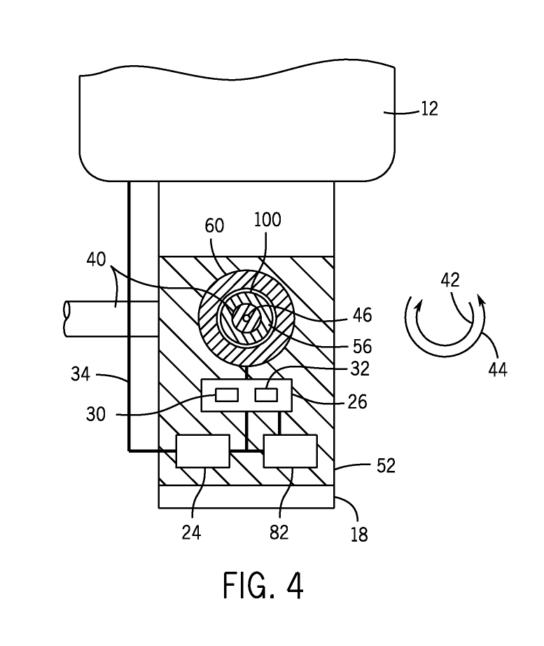

FIG. 4 is a cross-sectional side view of an embodiment of a power supply system 20 directly coupled to the manual actuator 40. As illustrated, the housing 52 houses the cascade 24, the controller 26, and the power source 22. In FIG. 4, the power source 22 is an electric generator 54 that includes the magnet 56 (e.g., permanent magnet) and stator coils 60. As illustrated, the housing 52 includes an aperture 100 that enables the manual actuator 40 to enter the housing 52 and couple to the magnet 56. In operation, as the manual actuator 40 rotates about the axis 46 in the clockwise and counter-clockwise directions 42, 44, the magnet 56 likewise rotates. The changing magnetic field, induced by the motion of the permanent magnet 56, forms an electrical signal (e.g., current) within the stator coils 60 that travels from the stator coils 60 to the controller 26. As the electrical signal enters the controller 26, the controller 26 adjusts the electrical signal (e.g., convert alternating current into direct current). The electrical signal then exits the controller 26 and enters the cascade 24. In the cascade 24, the voltage of the electrical signal is increased and then transmitted through cable 34 to the tank 12 and/or hose 36 to electrically charge the fluid.

As explained above, the electrostatic spray system (e.g., an electrostatic backpack spray system) enables a mobile operator to simultaneously pressurize and electrically charge fluid during spraying operations (e.g., spraying plants). Indeed, the mechanical power from the manual actuator enables the power supply system to generate electricity that electrically charges the fluid. The compressor likewise uses the mechanical power of the manual actuator to pressurize the tank enabling the electrostatic spray system to spray fluid.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A system, comprising:
an electrostatic spray system, comprising:
a tank configured to carry a fluid;
a power supply system coupled to the tank and configured to electrically charge the fluid while spraying; and
a manual actuator coupled to the power supply system, wherein the manual actuator is configured to drive power production by the power supply system.

2. The system of claim 1, comprising a compressor coupled to the manual actuator, wherein the manual actuator is configured to drive the pump to pressurize the fluid within the tank.

3. The system of claim 1, comprising a compressor coupled to the tank, wherein the compressor is configured to pressurize the fluid within the tank.

4. The system of claim 1, wherein the power supply system is configured to electrically charge the fluid.

5. The system of claim 1, wherein the manual actuator couples to a cam, and wherein the cam is configured to axially drive a magnet within an electric generator of the power supply system to produce electricity for electrically charging the fluid.

6. The system of claim 1, wherein the manual actuator couples to a magnet, and wherein the manual actuator is configured to rotate the magnet within an electric generator of the power supply system to generate electricity for electrically charging the fluid.

7. The system of claim 1, wherein the power supply system comprises a photovoltaic cell configured to generate electricity for electrically charging the fluid.

8. The system of claim 1, wherein the power supply comprises a battery configured to provide electricity for electrically charging the fluid.

9. The system of claim 1, wherein the electrostatic spray system comprises a wearable electrostatic spray system.

10. A system, comprising:
a wearable electrostatic spray system, comprising:
a tank configured to hold a fluid; and
a power supply system configured to electrically charge the fluid.

11. The system of claim 10, comprising a controller configured to control power output by the power supply system.

12. The system of claim 10, wherein the power supply system comprises at least one photovoltaic cell coupled to the tank and configured to generate electricity, to charge the fluid, power electronics of the wearable electrostatic spray system, or a combination thereof.

13. The system of claim 10, wherein the power supply system comprises a battery configured to provide electricity to charge the fluid, power electronics of the wearable electrostatic spray system, or a combination thereof.

14. The system of claim 10, wherein the power supply system comprises a capacitor configured to store electricity to charge the fluid, power electronics of the wearable electrostatic spray system, or a combination thereof.

15. The system of claim 10, wherein the power supply system comprises an external power source configured to provide electricity to charge the fluid, power electronics of the wearable electrostatic spray system, or a combination thereof.

16. The system of claim 10, wherein the power supply system comprises an electric generator to provide electricity.

17. The system of claim 16, comprising a manual actuator drivingly coupled to the electric generator.

18. The system of claim 17, wherein the manual actuator comprises a lever, a wheel, a pedal, a pull-string, or any combination thereof.

19. The system of claim 17, wherein the manual actuator is configured to rotate and/or translate a portion of the electric generator.

20. A system, comprising:
a wearable electrostatic spray system, comprising:
a tank configured to carry a fluid;
a power supply system comprising an electric generator coupled to the tank and configured to electrically charge the fluid; and
a manual actuator coupled to the power supply system, wherein the manual actuator is configured to drive the electric generator to produce electricity.
